(19) United States
(12) Patent Application Publication
(10) Pub. No.: US 2018/0248869 A1
(43) Pub. Date: Aug. 30, 2018

(54) MOBILE DEVICE THEME PARK OR RESORT EXPERIENCE DONGLE

(71) Applicant: PANASONIC INTELLECTUAL PROPERTY MANAGEMENT CO., LTD., Osaka (JP)

(72) Inventors: John CRONIN, Bonita Springs, FL (US); Seth Melvin CRONIN, Essex Junction, VT (US); Yoshihiro OKUMURA, Osaka (JP)

(21) Appl. No.: 15/905,402

(22) Filed: Feb. 26, 2018

Related U.S. Application Data
(60) Provisional application No. 62/464,809, filed on Feb. 28, 2017.

(51) Int. Cl. H04L 29/06; H04L 29/08; H04L 9/32

(52) U.S. Cl. CPC H04L 63/0853; H04L 69/08; G06F 3/0482; H04L 9/3242; H04L 63/0428; H04L 67/141

(57) ABSTRACT

A system and method for a universal device accessory (i.e. dongle) that is compatible with various different user devices (e.g. smartphones, tablets) that includes functionalities associated with the particular location (e.g. resort, theme park) is described herein. The universal device accessory would be designed specifically for the location in order to provide the user device with a streamlined suite of tools that would allow the user to interact with the location's native software and infrastructure through the user device. In this way, each location may have their own device accessory that facilitates various different user devices (e.g. smartphones, tablets) to be compatible with the software and infrastructure available at that location would simplify user interactions with the location.

### CROSS REFERENCE TO RELATED APPLICATIONS

This application claims priority to U.S. Provisional Application No. 62/464,809 filed on Feb. 28, 2017, the entire contents of which are hereby incorporated by reference.

### BACKGROUND

### Field of Invention

The present disclosure generally relates to device accessories. In particular, the present disclosure relates to a universal device accessory that integrates functionalities associated with a particular location.

### Description of the Related Art

Many different locations (e.g. resorts, theme parks) may have different systems for carrying out a variety of different functionalities on their premises. For example, a resort or theme park may have their own system for facilitating payment of services, collecting media content (e.g. image, video and/or audio recordings) and providing rewards to their guests. These functionalities may be carried out through the use of one or more applications that are downloadable onto user devices (e.g. smartphones, tablets).

The use of these functionalities aims to simplify the guest experience while at the resort or theme park. For example, the user would be able to use the application to pay for food or services without the need to present identification or carry a wallet containing credit cards or cash. Users would not need to carry their own cameras if they know that existing cameras associated with the resort or theme park are able to capture images, video and/or audio on their behalf to be downloaded at a later time.

A problem arises, however, since users may have a variety of different user devices (e.g. smartphones, tablets). It is difficult to provide an application that is compatible with the different user devices, which each have their own capabilities and operating system. For example, an application programmed for the iPhone/iOS operating system may not be compatible with other smartphones and their corresponding operating system (e.g. Samsung Galaxy/Android operating system). There is a need for a universal device accessory associated with the location (e.g. theme park or resort) that can be designed to be compatible with the different user devices. The universal device accessory can then provide users with a streamline suite of tools that interact with the location's (e.g. resort, theme park) native systems associated with the various functionalities that are aimed at making the user's experience more enjoyable.

### SUMMARY OF THE DISCLOSURE

Embodiments of the present disclosure include systems and methods directed towards providing compatibility between user devices with location infrastructure. The user device is associated with a user device accessory that converts information from the user device into a format compatible with the location infrastructure. Furthermore, the user device accessory includes software that facilitates communication between the user device and the location infrastructure so that the user can utilize services carried out by the location infrastructure.

### BRIEF DESCRIPTION OF THE DRAWINGS

FIG. 1 illustrates an example system using the device accessory.

FIG. 2 is a detailed illustration of an example device accessory.

FIG. 3 illustrates example graphical user interfaces of the location-based application associated with the device accessory.

FIG. 4 illustrates a method of the payment software.

FIG. 5 illustrates a method of the photo software.

FIG. 6 illustrates a method of the access software.

FIG. 7 illustrates a method of the user preference software.

FIG. 8 is a block diagram of an exemplary computing device that may be used to implement an embodiment of the present disclosure.

FIG. 9 illustrates an exemplary transaction of requesting goods and/or services.

FIG. 10 illustrates an exemplary implementation of the system.

FIG. 11 illustrates an exemplary authentication process.

### DETAILED DESCRIPTION

The present application describes systems and methods for utilizing a universal device accessory (i.e. dongle) that is compatible with various different user devices (e.g. smartphones, tablets) that includes functionalities associated with the particular location (e.g. resort, theme park). The term “dongle” refers to a small device that is able to be connected to and used with another computing device to allow access to wireless broadband or use of protected software. In this case, the universal device accessory would be designed specifically for the location in order to provide the user device with a streamlined suite of tools that would allow the user to interact with the location's native software and infrastructure through the user device. Communication between the user device and the location's native software and infrastructure can be carried out using any available network at the location (e.g. NFC, Bluetooth, WiFi, Internet).

Locations (e.g. resorts, theme parks) may have various software and infrastructure available that facilitates different services at the location. For example, such functionalities that may be carried out from the various software and infrastructure may include authorizing entry of users into an area, processing and approving payment for food and services, providing information, updates and promotions regarding events occurring at the location to the user device, and allowing user interactions with various objects placed throughout location.

The ability to allow each location to have their own device accessory that facilitates various different user devices (e.g. smartphones, tablets) to be compatible with the software and infrastructure available at that location would simplify user interactions with the location. Instead of creating multiple applications to be compatible with each user device that the user would have to individually download and update, the device accessory can include the different versions that can be kept up-to-date and allow compatibility between different user devices and the location.

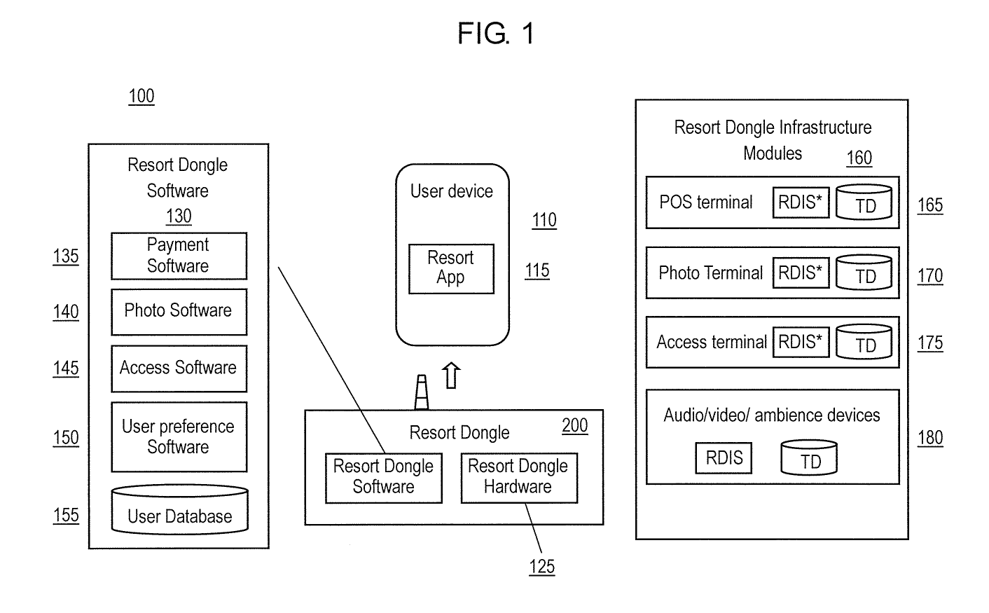

FIG. 1 illustrates an example system 100 using the device accessory. The device accessory may also be referred to as a dongle (as illustrated in the figure). The system 100 includes a user device 110, a corresponding device accessory/dongle 200 specific to the location (i.e. resort, theme park), and existing location software and infrastructure 160 (herein referred to location infrastructure). Additional details about each of the elements of the system 100 illustrated in FIG. 1 will be provided below.

The user device 110 can be any type of computing device presently available. For example, the user device 110 may be a smartphone or tablet. Each user device 110 may include their own capabilities and operating system (e.g. iOS, Android). The user device may be capable of downloading various applications that can be stored and executed on the user device 110. For example, a location-specific application may be downloaded and used with the user device 110 to allow users to communicate with the location infrastructure 160.

The location device accessory (e.g. dongle) 200 may have a physical (or wireless) interface with the user device (e.g. smartphone or tablet). For physical interfaces, known connectors may be used such as audio connector, lightning connector, and USB connectors. In the case of wireless interfacing between the device accessory 200 and the user device 110, the device accessory 200 may include antennae that sends data to the user device 110 and receives data from the user device 110. Example methods for wireless transmission of data between the user device and the accessory may include NFC, Bluetooth, RFID, and Wi-Fi. Indicators such as LED lights (not shown) may be provided on the device interface 120 to provide user feedback that a connection between the device accessory 200 and the user device 110 has been established. The user device 110 may also provide a visible notification on a display associated with the user device 110 informing the user that the connection has also be established with the device accessory 200.

The user device 110 includes an application 115 that is used to communicate with the device accessory 200. The application 115 may be pre-installed on the user device 110 or downloadable from various sources such as the internet or a database associated with the location (e.g. resort, theme park). The communication performed with the application 115 includes transmission of data between the user device 110 and the device accessory 200 and display of information associated with the device accessory 200 on the user device 110.

A variety of different user devices 110 may be compatible with a single type of device accessory 200 associated with a particular location (e.g. resort, theme park). This compatibility allows the device accessory 200 to process the inputs coming from the different user devices 110. As described above, the user devices 110 may have various different capabilities and operating systems. Therefore, the process performed by the device accessory 200 transforms the communications coming from the user device 110 into a format that may be understood by the location's infrastructure 160.

The transformation described above that processes the information coming from the user device 110 into a format that is compatible with the location's infrastructure 160 is facilitated using the hardware 125 and software 130 components associated with the device accessory 200. The hardware components 125 process the information and signals coming from the user device 110 into a format understood by the location's infrastructure 160. Once compatibility between the user and the location's existing software and infrastructure has been achieved using the hardware components 125, the software components 130 of the device accessory 200 facilitates communication with the location's infrastructure 160.

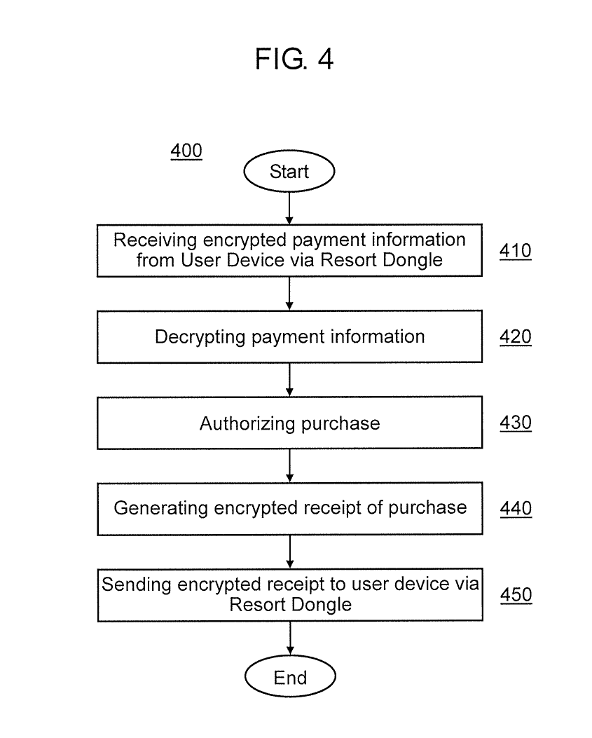

With respect to existing software at the location (e.g. resort, theme park), the device accessory 200 may include various different software components 130 as illustrated in FIG. 1 to communicate with the location's infrastructure 160. For example, the software components may include payment software 135, photo software 140, access software 145, user preference software 150, and a user database 155. The payment software 135 is used to process payments from the user device that will be accepted by the location's point of service (PoS) terminal 165. The PoS terminal 165 facilitates automatic payments or online payments associated with various services at the location. The photo software 140 communicates with the photo terminals 170 associated with the location that will take images, video and/or audio recordings on the location's devices. Afterwards, the images, videos and/or audio recordings can be transmitted using the photo terminals 170 back to the user device 110 automatically or on request. The access software 145 facilitates user access to various terminals 175 associated with the location. The access terminals 175 can identify whether a user has permission to access an associated area and provide such notification to the user. Lastly, the user preference software 150 allows the user to communicate with the location's infrastructure to customize features respective to the user's preference (if possible/applicable). For example, the audio, video and/or ambience devices 180 may include details particular to the user's profile/database 155 provided from the user preference software 150. Additional details about each of the example software components 130 included in the accessory device 200 will be provided below with respect to FIGS. 4-7.

It should be noted that there may be more or less software components 130 associated with the accessory device 200 as illustrated in FIG. 1. Furthermore, there may be more or less existing software and infrastructure associated with the location infrastructure 160 than what is illustrated in the figure. The corresponding relationship between the software components 130 of the accessory device 200 and the location infrastructure 160 are therefore dependent on the available software components 130 and location's infrastructure 160.

The location device accessory (e.g. dongle) 125 may be provided to each user upon entry into the location. The condition for providing the accessory may be based on, for example, an entry fee associated with entry into the location (i.e. resort, theme park). In other situations, the user may be required to purchase the accessory or provide a deposit to obtain the accessory on loan for the duration of the user's visit to the location.

The location infrastructure 160 facilitates providing various goods and/or services to the user. The user is able to, for example, request goods and/or services through the use of the application on the user device and transmission of the request using the device accessory. For example, the location infrastructure 160 carries out functionalities such as processing payment, capturing recordings, providing access, and user customization based on user preferences by receiving user input from the user device via the device accessory. Each of the existing location's infrastructure 160 components can each cover one or more functions described above. With each location infrastructure 160, there is associated software (RDIS) and a database (TD) that that facilitates the functionality of the corresponding infrastructure 160.

For example, the PoS terminal 165 may facilitate automatic payments or online payments associated with various services at the location. The PoS terminal 165 would include software that would be used to dictate how to receive, process, and confirm payment from the user via the user device 110. The PoS terminal 165 would also include a database that would include the data associated with the receipt, processing and confirmation of payment (i.e. balance due for each user, individual cost for service, confirmation of payment).

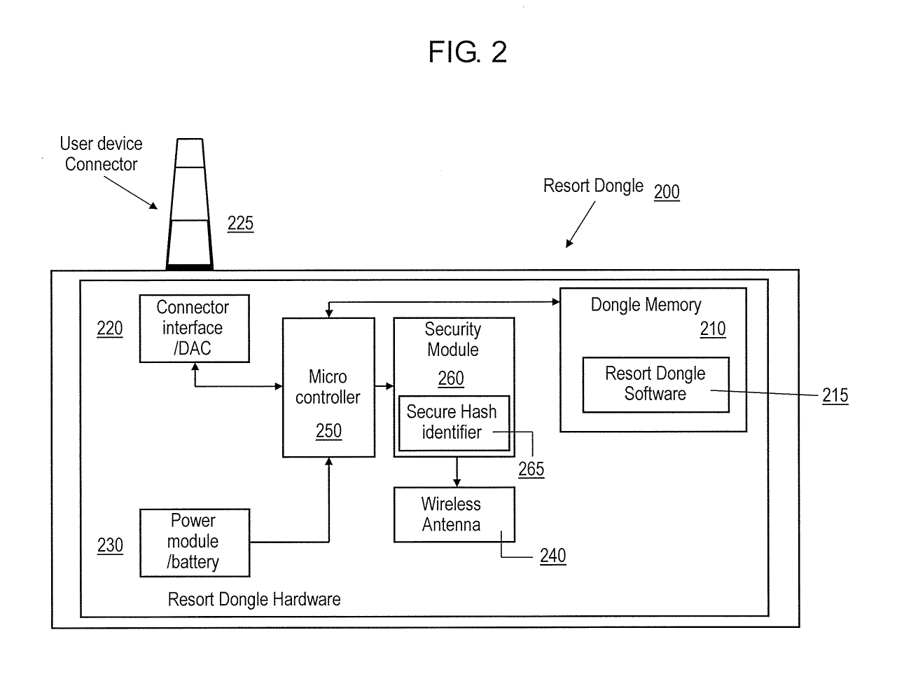

FIG. 2 is a detailed illustration of an example device accessory 200. The device accessory 200 may include a variety of different components. For example, the device accessory 200 may include memory 210 for storing instructions such as associated software 215 that is needed for running the various functionalities of the device accessory 200. The memory 210 can also include information used to make the device accessory 200 compatible with different user devices. For example, various conversions or transformations can be stored that standardizes information coming from different user devices into a format that is compatible with the location's infrastructure.

The device accessory 200 may also include a connector interface 220 that facilitates transmission of data between the user device and the device accessory coming from the associated user device connector 225. The user device connector 225 may be a wireless connection or a physical connection. In situations where the user device connector 225 is a physical connection, example connectors may include existing audio connectors, lightning connectors and USB connectors. Wireless connection via the user device connector 225 may be an antenna that transmits data between the user device and the device accessory 220 using methods such as NFC, Bluetooth, Wi-Fi or RFID.

The device accessory 220 may also include an internal antenna 240 that is capable of sending and/or receiving data from various sources such as the existing location's infrastructure. A battery 230 can be included to provide a source of power for running the device accessory 200 that is separate from the user device. It may be possible that the device accessory 200 may share power from the user device, in which case the battery 230 may not be necessary or be reserved for when the user device power supply is below a pre-determined threshold. The micro controller 250 facilitates the processing of the instructions 215 stored in memory 210 for running the device accessory 200. Lastly, the security module 260 with associated secure hash identifier 265 provides a secure method of communication for each device accessory 200 between the device accessory 200 and the location's infrastructure. In particular, the security module 260 implements encryption/decryption of communications between the user device (via the device accessory) and the location's infrastructure. The secure hash identifier 265 provides the unique encryption/decryption used for each device accessory.

The device accessory 200 may also include indicators (e.g. LED lights) (not shown) that can be used to provide information to the user such as whether a connection between the device accessory and the user device is detected or whether the battery for the device accessory 200 is healthy.

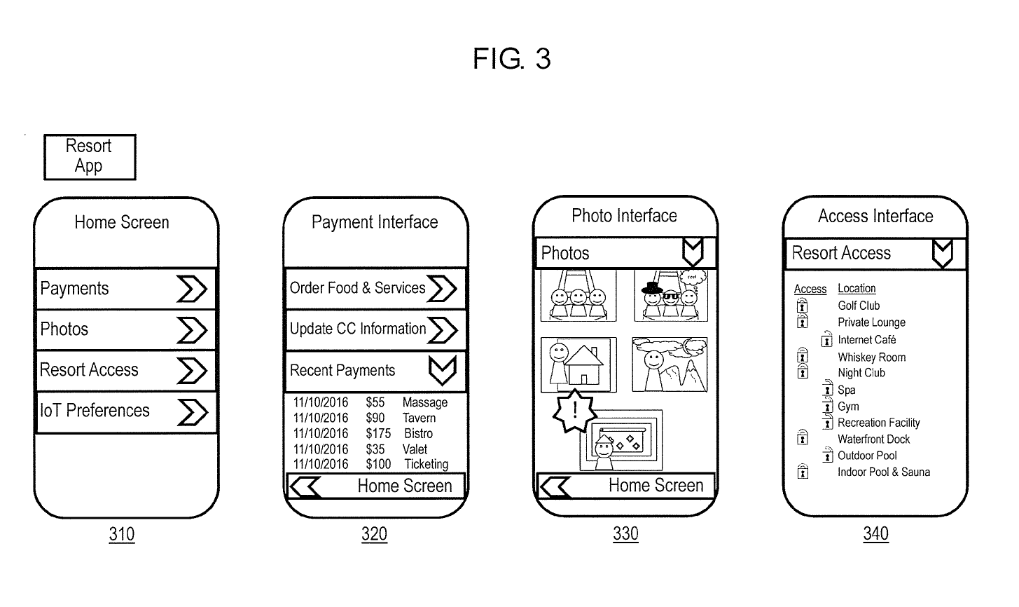

FIG. 3 illustrates example graphical user interfaces of the location-based application associated with the device accessory. As described above, the user device may include an application that facilitates communication between the user device, the device accessory and the location (e.g. resort, theme park) infrastructure. Each of the graphical interfaces illustrated in the figure provides a different functionality that the user may interact with associated with the location infrastructure.

With reference to the home screen GUI 310, a user can be provided a menu with a plurality of possible functionalities that can be chosen. These functions can correspond with communicating with the device accessory and/or the location infrastructure. The functions can also include inputting user preferences for future use/reference with the device accessory and/or location infrastructure.

Selection of one or more options shown in the home screen GUI 310 can bring up subsequent graphical user interfaces associated with the chosen function. For example, selection of the payment, photo, and/or access functions displayed on the home screen GUI 310 could bring up corresponding GUIs for payment 320, photo 330, and/or access 340.

The payment interface GUI 320 can be used to facilitate user payment for goods and services at the location using the location infrastructure. For example, the payment interface GUI 320 can allow the user to select what goods and/or services to order, update payment options (e.g. credit card information) as well as provide a history of payment transactions for a pre-determined period of time. The payment interface GUI 320 provides the information regarding orders and/or payment to the device accessory which in turn transmits the information to the location infrastructure to be processed and carried out.

The photo interface GUI 330 can be used by the user to view all images, video and/or audio recordings that were captured using the location infrastructure. Example location infrastructure may include environments where one or more cameras and/or microphones are associated with a ride or attraction that a user participates in. The user may request that the location capture/record the user's experience while participating in the ride or attraction. The cameras and/or microphone may capture various images, video and/or audio recordings that are temporarily stored in memory within the location infrastructure. The user can then view, modify and/or download the recordings to the user device.

The photo interface GUI 330 can communicate with the location infrastructure to view the images, video and/or audio recordings that are stored on the location infrastructure. It may also be possible to view the same images, video and/or audio recordings after they have been downloaded from the location infrastructure (i.e. stored on the user device) using the photo interface GUI 330. There may also be additional functionality where the user is able to modify the images, video and/or audio recordings through the use of the photo interface GUI 330.

The access interface GUI 340 can be used by the user to identify various access-capabilities that the user device may have at a particular location's infrastructure. There may be ‘locked’ and ‘unlocked’ indicators that differentiate what location-based infrastructure the user does not currently have access to or currently has access to, respectively. In one example, the ‘locked’ and ‘unlocked’ indicators may represent whether the user has functional access based on the capabilities of the device accessory. The device accessory software may not be up-to-date and therefore not compatible with current software run by the location infrastructure. In other situations, the user may need to be authorized to access the functions to have access to that particular infrastructure where authorization may require some form of payment (e.g. payment of service fee, subscription fee).

The user may also manually provide ‘locked’ or ‘unlocked’ indication based on the type of access they would like to have. For example, the user may not wish to connect with the golf club infrastructure or private lounge infrastructure and may then choose to prevent the user device from communicating with the respective location-based infrastructure using the access interface GUI 340.

FIG. 4 illustrates a method 400 of the payment software. As described above, the payment software is used to process payments from the user devices that will be accepted by the location's infrastructure (e.g. PoS terminals). In this way, users are able to utilize their user devices to order and pay for goods and services.

In step 410, order and/or payment information can be provided from the user device to the location's infrastructure (e.g. PoS terminals). For example, the user may choose to pre-order food while standing in line for a restaurant at a resort and also pay for the food. In this way, the food can be prepared ahead of time and ready for pick-up at a designated time.

The order and payment from the user device is generally encrypted via the device accessory. As described above in FIG. 2, the device accessory includes the security module and secures hash identifier. These components facilitate encrypting/decrypting the information transmitted between the user device and the location's infrastructure so that the communications can be secure.

In step 420, the location's infrastructure (e.g. PoS terminals) receives the information from the user device regarding order and/or payment of goods and/or services. The location's infrastructure would be capable of decrypting the received communications from the user devices by using associated keys stored in the database associated with the infrastructure (e.g. PoS terminal).

In step 430, the location's infrastructure and process the received information. This includes authorizing any payment for goods and/or services and providing confirmation of payment to the user and/or vendor associated with the location's infrastructure. Furthermore, the process may also forward the user's order for goods and/or services to the vendor for fulfillment.

For example, once the user transmits an order and payment for the order, the location's infrastructure can process the payment and provide confirmation of payment to both the user and/or vendor (e.g. restaurant). Furthermore, the user's order of what food they would like to have is also provided to the vendor (e.g. restaurant).

In step 440, the location's infrastructure (e.g. PoS terminal) can generate an encrypted receipt of purchase associated with the user's order and payment for goods and/or services. By using the associated hash identifier and key stored in the database associated with the location's infrastructure (e.g. PoS terminal), the receipt of purchase can be encrypted for secure transmission (in step 450) to the user device. The encrypted receipt is received by the device accessory, for example via the internal antenna. Once received, the security module of the device accessory can decrypt the encrypted transmission so that the user is able to view the receipt on the user device.

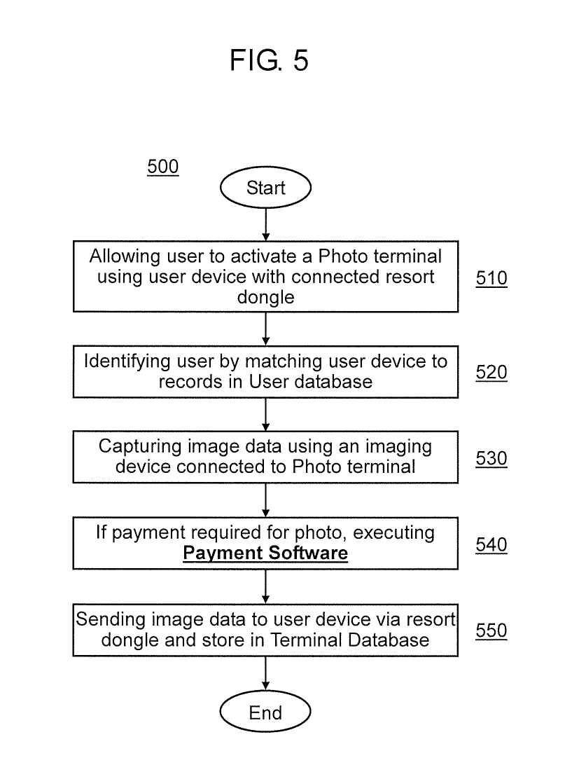

FIG. 5 illustrates a method 500 of the photo software. As described above, the user can utilize the photo software to communicate with various photo terminals associated with photo terminals at the location to take images, video and/or audio recordings. For example, an attraction or ride may have multiple cameras, microphones or other devices to record the user's image, video and/or audio in a recording. These recordings provide a way for the user (with the use of photo terminals) to capture the user's experience without the need to use their own camera. The photo software can be used by the user to indicate that such recordings are desired, to control various characteristics of the recordings, and to view/modify/download the recordings when available.

In step 510, the user communicates with the location infrastructure (in this case a photo terminal) using the application and associated device accessory. The communication can include indicating a request to capture image, video and/or audio recordings associated with the user's experience associated with the photo terminal. As described above, the photo terminal may be associated with a ride (e.g. roller coaster) that includes cameras and/or microphones for recording the user's experience. Other example embodiments may include a photo terminal that facilitates photographs in front of scenic views or other attractions at the location.

In step 520, user profile information is provided from the user device to the location infrastructure (e.g. photo terminal). The user profile is used to match the user device with information of the user in the database associated with the photo terminal. For example, the database may include memory set aside to store all requested image, video and/or audio recordings for subsequent viewing, modification and/or download by the user (via the user device). The recordings may also be tagged with the information associated with the user profile and/or user device so that the recording can be transmitted to the appropriate location after it has been completed.

In step 530, the recording (e.g. image, video and/or audio) is captured by the location infrastructure (e.g. photo terminal). The capturing is performed, for example, based on default settings associated with the photo terminal or using various preferences provided by the user via the photo software. Once captured, the recording can be stored in a database associated with the location infrastructure (e.g. photo terminal). As described above, the recording can be stored associated with the user profile and/or device identification so that the user can search for and access, modify and/or download the recording in the future.

In step 540, payment software (as described above in FIG. 4) can be executed in situations where payment is requested for use of the photo terminal. The payment software can request and process payment for the services associated with the photo terminal. Once payment has been confirmed, the user may be provided authorization to view, modify and/or download the recordings requested by the user using the photo software. In various embodiments, the payment software (in conjunction with the photo terminal) can be used to provide different conditions and pricing associated with the capture, modification and/or download of recordings be provided different pricing. For example, the user may pay a first fee to capture and download image recordings, a second fee may be associated with capture and download of video and/or audio recordings, and a third fee may be associated with the ability to modify the recordings and so on.

In step 550, once confirmation of the payment (if required) is confirmed, the recording can be transmitted to the user device. Transmission can be performed automatically (after confirmation of payment) or upon request by the user using the photo software. In some embodiments, especially where payment is not required or if pre-payment for services has been performed, it may be possible that transmission of the captured recordings to the user device can be performed automatically after the recording of the image, video and/or audio has been completed.

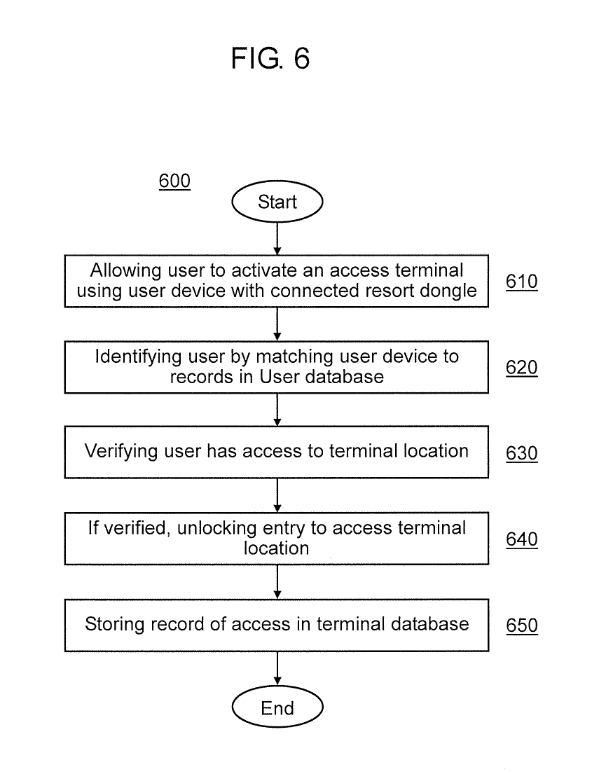

FIG. 6 illustrates a method of the access software 600. As described above, the access software facilitates user access to various areas associated with access terminals. The access software can provide information to the user regarding what authorization/permission the user may have with respect to corresponding access terminals and areas.

In step 610, the user is allowed to activate an access terminal using the user device via the device accessory. The user device, using the application, can communicate with corresponding access terminals to gain access to an area. For example, there may be gates/doors that are associated with access terminals that may require user identification prior to opening. The access terminal can be activated by the user, via the access software, to request that the gate/door be opened.

In step 620, the access software provides the user profile and/or user device identification to the access terminal. Based on the information stored associated with the access terminals, user profile and/or user device identification may be used to match against authorized users and/or user devices that are allowed access beyond a gate/door.

In step 630, verification of the identity of the user with the database associated with the access terminal is performed. If the user profile and/or user device appears on in the database identifying that the user is authorized access, the software proceeds to step 640 whereby the gate/door is opened and the user is allowed to enter.

There may be situations where the database may not have been updated but the user is authorized to enter the gate/door via a recent purchase (perhaps via the payment software). For example, access beyond the access terminal may require a fee. The access software can also identify any associated confirmation of payment (if applicable) associated with authorizing access past the access terminal. Even if the user is not found in the database associated with the access terminal, the confirmation of payment would also instruct the gate/door to open (via step 640). Furthermore, the database associated with the database associated with the access terminal may be updated to include the user profile and/or device identification information.

In step 640, the access software provides instructions to the associated gate/door to open for the user who has been confirmed authorized to enter the area associated with the access terminal.

In step 650, the access software can store a record of the user (via the user profile information and/or user device identification) accessing the area associated with the access terminal in the associated database. Recording access in the database may be important to track the number of users entering and/or leaving the area. This information can be used to manage how many more people may be allowed within the associated area. Furthermore, there may be areas which allow a limited number of accesses within a pre-determined period of time or only allows an initial access but no re-entry. By recording the instance when the user accesses the area, the access software can confirm whether the user would be allowed to enter the area at a future time (i.e. after a previous exit).

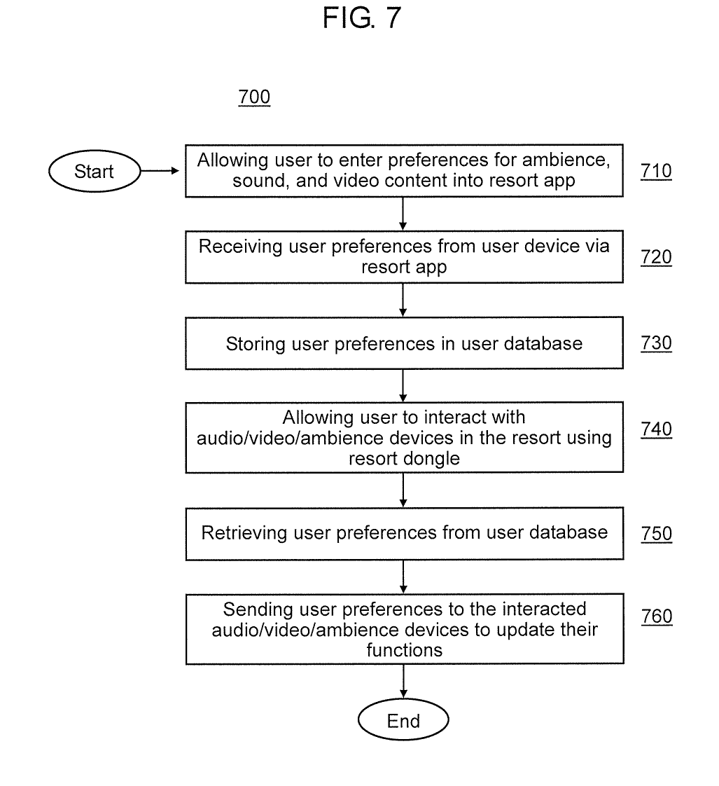

FIG. 7 illustrates a method 700 of the user preference software. As described above, the user preference software allows the user to communicate with the location's infrastructure in order to customize features respective to the user's preference (if applicable). For example, the user may wish to have a particular type of ambience in their bedroom at a resort or prefer a particular type of music playing during their ride at a theme park.

In step 710, the user enters various user preferences using the user preference software at the user device. The user preferences may include user preferences such as ambience, sound, music, and video content that can be provided from the location infrastructure.

In step 720, the user preferences can be transmitted using the application to the location infrastructure via the device accessory. The user preference information may be provided via a secure transmission (i.e. encrypted) much like the payment software described above in FIG. 4.

In step 730, the user preferences are stored in database associated with the location infrastructure. In some embodiments the user preference may be stored at a central database that is accessible by all location infrastructures. Alternatively, corresponding user preferences may be provided to specific applicable location infrastructure database.

In step 740, the user can interact with location infrastructure to request goods and/or services associated with the user preference previously inputted in step 710. If applicable, the user may request that various preferred features be implemented if possible using the application on the user device. For example, upon entering the user's room at a resort, the user can indicate on the application a preferred lighting, ambience, and temperature setting for the room. Other preferences may include the type of music to be played or information to be provided to the user device.

In step 750, the associated location infrastructure that receives the user request for goods and/or services from the user via the user device searches for the corresponding user preference information stored in the database. Once the user profile and/or user device identification information is matched, the corresponding user preferences may be retrieved.

In step 760, the retrieved user preferences are provided to the location infrastructures that are applicable to carry out the user preferences indicated by the user. In the example above with respect to the lighting, ambience and temperature of the room, the user preference may be provided to devices associated with controlling the lights, music/sound, and the thermostat so that they can be adjusted to satisfy the user preferences.

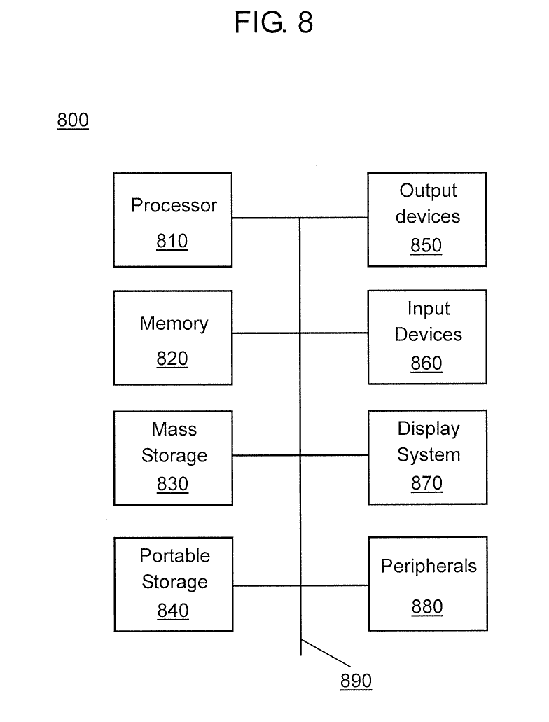

FIG. 8 illustrates an exemplary computing system 800 that may be used to implement an embodiment of the present disclosure. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present disclosure for purposes of loading that software into main memory 820.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present disclosure may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. For example, peripheral device(s) 880 may include a modem or a router.

The components contained in the computer system 800 of FIG. 8 are those typically found in computer systems that may be suitable for use with embodiments of the present disclosure and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

Referring again to FIGS. 1 and 2, the device accessory 200, also referring to as the dongle herein, includes the security module 260 having the hash identifier (secure hash identifier 265). The dongle can be identified with the hash identifier. Therefore, the dongle can be identified regardless of the carrier/user who is carrying the dongle. In other words, the dongle relates each ride experience with the user corresponding to the dongle.

The user device is not always capable of communicating with the location infrastructure. Specifically, the location infrastructure may require different wireless interface techniques or components dependent on the services. As described above, the dongle provides a wireless interface which is compatible with the location infrastructure. The dongle can connect with the user device using the user device connector 225. Therefore, the dongle (resort dongle or device accessory 200) allows the user device to communicate with the location infrastructure via the dongle.

The user device connector 225 is a physical and electrical interface between the dongle and the user device. The dongle is physically connected to the user device. It is preferable to attach the dongle to the user device for stable connection through the user device connector 225. For example, the dongle can be attached to the user device using the user device connector 225. The dongle can be a cover case which is attached to the user device. The dongle can be implemented as an external battery. In this case, the power module/battery 230 of the dongle supplies power for the user device.

The location infrastructure may include security identifier information which is a database for managing information of hash identifier of the dongle. Therefore the system may identify each dongle uniquely using the security identifier information.

The dongle may also encrypt some transmitted data based on the hash identifier of the dongle. The communication between the dongle and the location infrastructure can be established independently.

The dongle may also include the battery 230 to source electric power for the dongle. When the dongle is detached from the user device, the battery 230 allows the user device to continue communicating with the location infrastructure. The battery may be a rechargeable battery. In such configuration, the dongle may recharge the battery with electric power supplied from the user device. The battery in the dongle improves communication stability. The battery also allows the dongle to inform the approximate location of the dongle to the location infrastructure whether detached from the user device. Therefore, each location of dongle in the park can be managed by the location infrastructure.

The location infrastructure may include a plurality of communication apparatus to communicate with the dongles. The plurality of communication apparatuses are distributed in the parks. The location infrastructure may include information of locations where the communication apparatuses are disposed. The plurality of communication apparatuses need not share a common communication procedure. On the other hand, the dongle is capable of communicating with the plurality of communication apparatus. For example, a first communication apparatus may communicate with the dongle over a NFC communication, and a second communication apparatus may communicate with the dongle over Wi-Fi. The dongle is capable of communicating over both the NFC communication and Wi-Fi. Therefore, the dongle is capable of communicating with the first communication apparatus and the second communication apparatus.

The dongle may establish communication with two communication apparatuses at the same time. When the dongle communicates with a communication apparatus for a first service, i.e. transaction payment, the dongle can establish another communication with a communication apparatus for a second service, i.e. event information of the park. In this configuration, the application on the user device can provide services without connection management which switches connection over communication systems or communication apparatuses. In other words, the dongle allows the application to manage connections for different communications/services independently of one another.

The dongle may also support one or more encryption/decryption codec. The dongle may communicate with a first communication apparatus for the first service using a first encryption code and a second communication apparatus for the second service using a second encryption code. Therefore, the dongle can support a plurality of communications for different services whether the encryption code is the same or not.

As noted above, the dongle may include a controller 250, a user device connector 225, a wireless communication device 240 and a security module 260 to provide compatibility between a user device with location infrastructure. The controller (i) receives information from the user device via the user device connector, (ii) converts the information from the user device into a format compatible with the location infrastructure, wherein the format compatible with the location infrastructure is different from a format compatible with the user device, (iii) receives user input, including requests for good and/or service, from the user device via the user device connector, (iv) encrypts the received user input from the user device, wherein the encryption is performed using a unique hash identifier associated with the dongle, (v) transmits the encrypted user input to the location infrastructure, wherein the transmitted location infrastructure corresponds to the requested good and/or service associated with the received user input, (vi) receives the confirmation from the location infrastructure, wherein the received confirmation is translated into the format compatible with the user device, and (vii) transmits the translated confirmation to the user device.

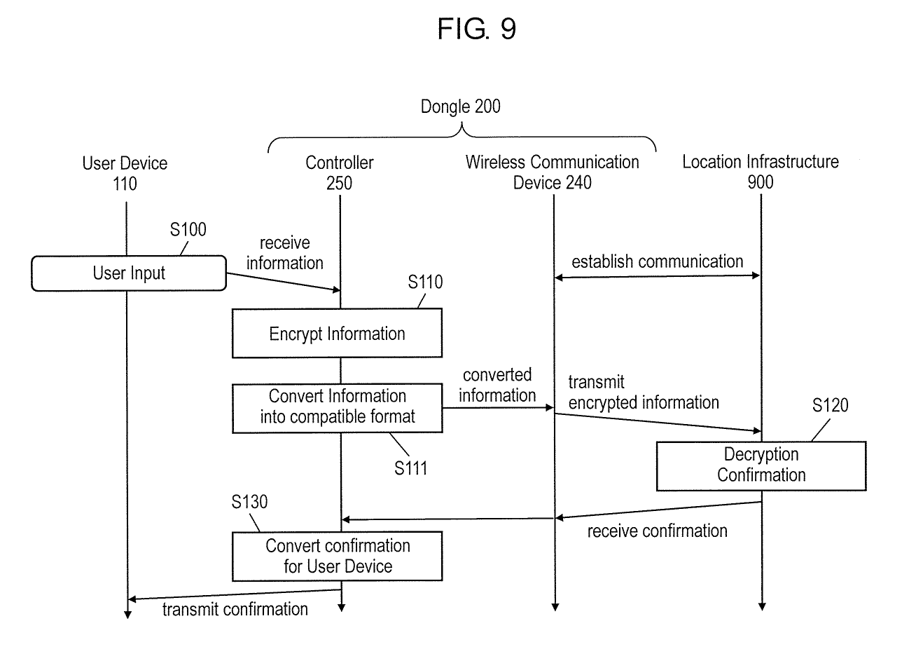

FIG. 9 shows an exemplary transaction of requesting goods and/or services. A user inputs a request for goods and/or services using the user device 110 and submits the user input (S100). The user device 110 transmits the information of user input to the dongle 200 which is connected to the user device 110 with the user device connector 225. Controller 250 of the dongle 200 encrypts the received information (S110). The controller 250 converts the encrypted information into a compatible format (S111). The compatible format is compatible with the connection between the wireless communication device 240 and the location infrastructure 900 of the requested goods and/or services (S111). Wireless communication device 240 transmits the encrypted information to the location infrastructure 900. The location infrastructure 900 receives and decrypts the encrypted information (S120). The decrypted information includes the information of goods and/or services requested by the user. When the request is confirmed, the location infrastructure 900 transmits the confirmation to the dongle 200. The controller 250 converts the information of the confirmation into a format which is compatible with the user device. Controller 250 transmits the confirmation to the user device via the user device connector 225.

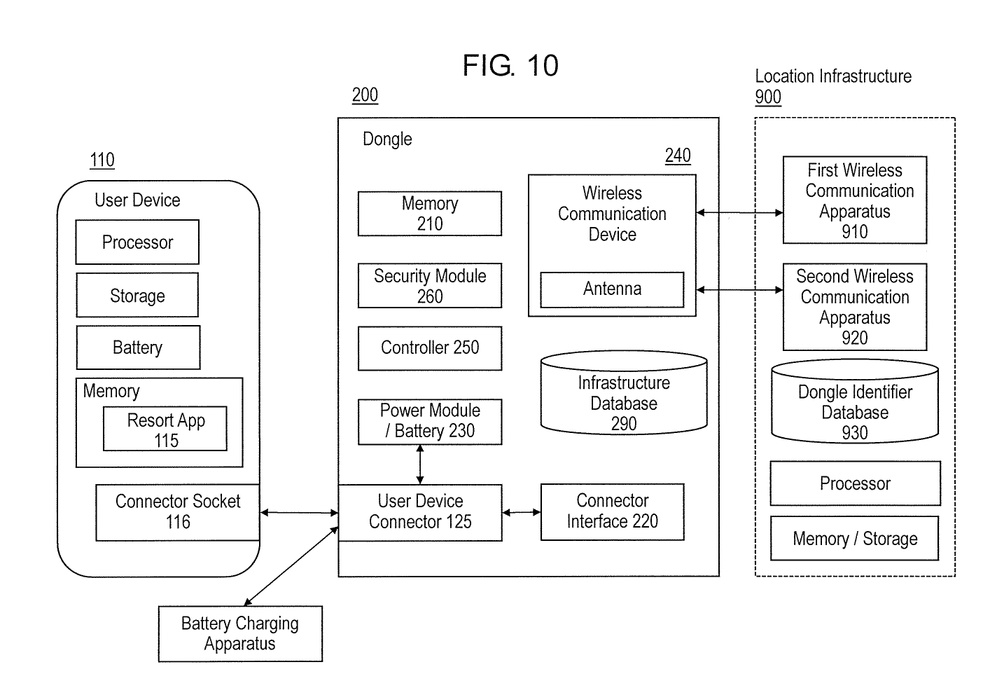

FIG. 10 shows an exemplary implementation of the system. The user device 110 includes processor, storage and memory. The resort application 115 supports the user device to connect with the system. The user device includes connector socket 116. For example, connector socket 116 is, for example, an earphone jack, USB socket or lightning connector. The dongle 200 includes user device connector 125 which is physically and communicatively connectable with the connector socket 116 of the user device. The connector interface 220 controls communication for compatibility between the dongle and the user device. The controller 250 may perform some or all functions of the connector interface 220. Power module/battery supplies electrical power to the dongle 200. Battery 230 can be recharged by a battery charging apparatus. The user device connector 125 can be used for recharging battery 230. The dongle 200 may have another connector for recharging battery 230. In an exemplary configuration, power module/battery 230 may receive power from the user device via the user device connector 125. In such configuration, power module/battery 230 covers peak power consumption, caused by wireless communication device 240, of the dongle 200 and supplies back-up power when the user device is disconnected. In another configuration, power module/battery 230 may supply power to the user device.

Location infrastructure may include first wireless communication apparatus 910 and second wireless communication apparatus 920 each having a different communication scheme. The wireless communication device 240 supports two or more communication schemes to provide compatibility with both of the first wireless communication apparatus 910 and the second wireless communication apparatus 920. The dongle 200 may include infrastructure database 290 which indicates procedures for each service. For example, a first service to buy goods and/or services at a shop, the first wireless communication apparatus corresponding to the shop is selected to the destination of the wireless communication. The infrastructure database 290 allows access to a secured (hidden) wireless communication apparatus using a key-code, which the infrastructure database 290 includes. For example, the key-code can be, for example, SSID and password for Wi-Fi access.

The dongle infrastructure may include dongle identifier database 930. When the location infrastructure 900 receives the secure hash identifier from a dongle 200, the secure hash identifier is authenticated using the dongle identifier database 930. Therefore, dongles not registered to the dongle identifier database 930 cannot pass the authentication process.

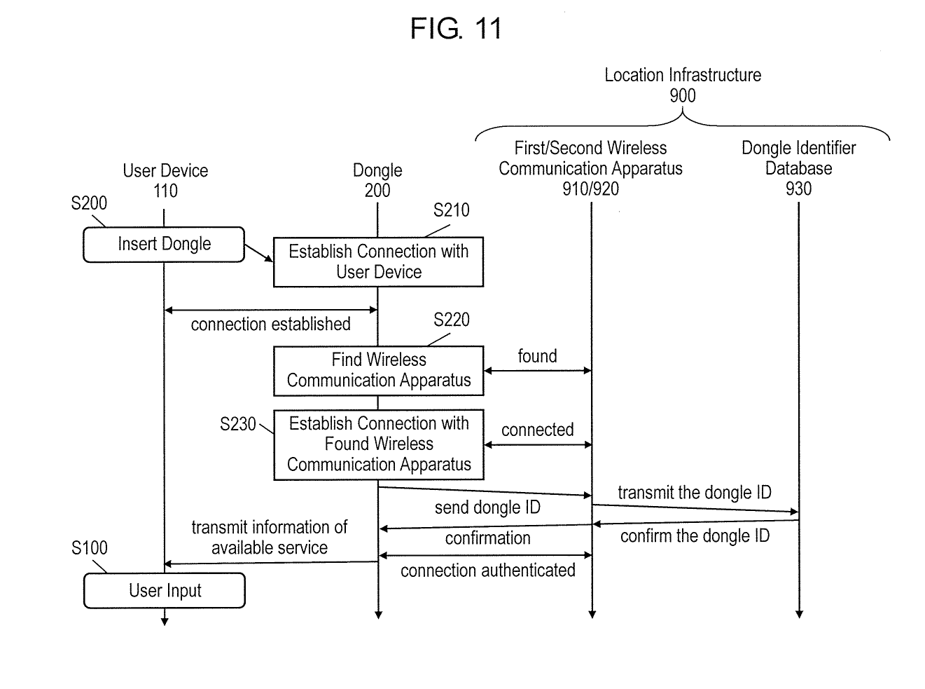

FIG. 11 shows an exemplary authentication process. When a user inserts the dongle into the user device 110 (S200), the dongle 200 starts to establish connection with the user device 110. The connector interface 220 manages to establish the connection between the user device 110 and the dongle 200. The dongle 200 may try to find wireless communication apparatus based on the infrastructure database 290 (S220). When a first wireless communication apparatus 910 for a first service is found, the dongle 200 tries to establish connection with the first wireless communication apparatus 910. The controller 250 controls the wireless communication device to connect with the first wireless communication apparatus 910 in the compatible scheme indicated by the infrastructure database 290. After the communication is established, the dongle 200 sends the dongle ID (secure hash identifier) to the first wireless communication apparatus for authentication of the connection. The first wireless communication apparatus 910 transmits the dongle ID and the location infrastructure 900 performs authentication based on the dongle identifier database 930. When the first wireless communication apparatus 910 receives the confirmation, the confirmation is transmitted to the dongle 200 and the connection is authenticated. The dongle 200 transmits information to the user device 110 that the first service is available.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for providing compatibility between user devices with location infrastructure, the system comprising:
location infrastructure utilized to carry out one or more functionalities associated with goods or services as requested by a user device at a location, wherein the location infrastructure:
decrypts transmissions from the user device, wherein the user device is communicatively connected to a dongle that provides an encrypted transmission in a format understood by the location infrastructure, wherein the decryption identifies user requested goods and/or services from the user at the user device,
processes the user requested goods and/or services, wherein the process includes generating instructions for corresponding devices to carry out the requested goods and/or services,
stores information associated with the requested goods and/or services in a database associated with the location infrastructure, wherein the stored information is associated with a user profile associated with the user, and
transmits confirmation for the user device regarding processing of the requested goods and/or services by the location infrastructure; and
a user device which:
receives user input, wherein the user input includes a request to be transmitted to the location infrastructure associated with a request for goods and/or services, and
transmits the received user input to a dongle communicatively connected with the user device, wherein the dongle is specific to the location infrastructure; and
a dongle that is communicatively connected with the user device, which:
converts information from the user device into a format compatible with the location infrastructure, wherein the format compatible with the location infrastructure is different from a format compatible with the user device,
encrypts the received user input from the user device, wherein the encryption is performed using a unique hash identifier associated with the dongle,
transmits the encrypted user input to the location infrastructure, wherein the transmitted location infrastructure corresponds to the requested good and/or service associated with the received user input, and
receives the confirmation from the location infrastructure, wherein the received confirmation is translated into the format compatible with the user device.

2. The system of claim 1, wherein the dongle includes a security module having a hash identifier for identifying the dongle.

3. The system of claim 2, wherein the location infrastructure includes security identifier information for identifying the dongle in the database, the security identifier information included in the location infrastructure uniquely identifies the dongle.

4. The system of claim 2, wherein the dongle encrypts the received user input from the user device based on the hash identifier of the dongle.

5. The system of claim 1, wherein the dongle includes a battery to source electric power for the dongle, wherein the battery can be recharged by the user device.

6. The system of claim 1, wherein the location infrastructure includes a plurality of communication apparatus which are capable of communicating with the dongle, and the dongle is configured to communicate with the plurality of communication apparatus.

7. The system of claim 6, wherein the plurality of communication apparatus includes a first communication apparatus for a first service and a second communication apparatus for a second service, and
wherein the dongle can establish communication with the first communication apparatus and the second communication apparatus independently of one another.

8. The system of claim 7, wherein the dongle can establish communication with the second communication apparatus regardless of whether or not the dongle has a communication established with the first communication apparatus.

9. The system of claim 6, wherein:
the plurality of communication apparatus includes a first communication apparatus for a first service and a second communication apparatus for a second service,
the dongle encrypts the received user input from the user device based on a first encryption code for the first service, and
the dongle encrypts the received user input from the user device based on a second encryption code, other than the first encryption code, for the second service.

10. A dongle for providing compatibility between a user device with location infrastructure,
the dongle comprising:
a controller,
a user device connector,
a wireless communication device, and
a security module,
wherein the controller:
receives information from the user device via the user device connector,
converts the information from the user device into a format compatible with the location infrastructure, the format compatible with the location infrastructure is different from a format compatible with the user device,
receives user input, including a request for good and/or service, from the user device via the user device connector,
encrypts the received user input from the user device, the encryption is performed using a unique hash identifier associated with the dongle,
transmits the encrypted user input to the location infrastructure, wherein the transmitted location infrastructure corresponds to the requested good and/or service associated with the received user input,
receives the confirmation from the location infrastructure, the received confirmation is translated into the format compatible with the user device, and
transmits the translated confirmation to the user device.

11. A system for providing compatibility between user devices with location infrastructure, the system comprising:
location infrastructure utilized to carry out a first service and a second service which are available from a user device at a location, the location infrastructure including:
a first communication apparatus for the first service, and
a second communication apparatus for the second service,
a dongle that is communicatively connected with the user device, the dongle including:
a user device connector which communicatively connects the dongle and the user device,
a wireless communication device configured to establish communication with the first communication apparatus and the second communication apparatus independently of one another,
a security module which stores a secure hash identifier,
a controller which controls the dongle,
wherein, when the dongle performs communication for the first service,
the controller controls the dongle to:
receive user input from the user device via the user device connector,
generate a first transmission for the first service based on the user input,
establish communication between the dongle and the first apparatus using the secure hash identifier, and
transmit the first transmission via the established communication,
the first communication apparatus performs:
identifying the dongle based on the secure hash identifier,
receiving the first transmission from the dongle,
wherein, when the dongle performs communication for the second service,
the controller controls the dongle to:
receive user input from the user device via the user device connector,
generate a second transmission for the second service based on the user input,
establish communication between the dongle and the second apparatus using the secure hash identifier, and
transmit the second transmission via the established communication,
the second communication apparatus performs:
identifying the dongle based on the secure hash identifier,
receiving the second transmission from the dongle.

12. The system of claim 11, wherein the dongle includes a battery to source electric power for the dongle, wherein the battery can be recharged via the user device connector.
